(19) United States
(12) Patent Application Publication
(10) Pub. No.: US 2014/0202776 A1
(43) Pub. Date: Jul. 24, 2014

(54) LOAD MEASURING SYSTEM

(71) Applicants: Daniel Kane, Glasgow (GB); Peter Johnston, Glasgow (GB)

(72) Inventors: Daniel Kane, Glasgow (GB); Peter Johnston, Glasgow (GB)

(73) Assignee: AYDAN INVESTMENTS LIMITED, Road Town, Tortola (VG)

(21) Appl. No.: 14/130,269

(22) PCT Filed: Jul. 3, 2012
(86) PCT No.: PCT/GB2012/051556

§ 371 Date: Mar. 25, 2014

(30) Foreign Application Priority Data
Jul. 4, 2011 (GB) 1111340.4

(51) Int. Cl. G01G 19/12; G01L 5/16

(52) U.S. Cl. CPC G01G 19/12; G01L 5/161
USPC 177/136

(57) ABSTRACT

There is herein described a load measuring system. More particularly, there is described a load sensor and panel comprising at least one of said sensors for measuring and/or monitoring a load and/or distribution of a load.

### FIELD OF THE INVENTION

The present invention relates to a load measuring system. More particularly, the present invention relates to a load sensor and panel comprising at least one of said sensors for measuring and/or monitoring a load and/or distribution of a load.

### BACKGROUND OF THE INVENTION

Load measuring systems are known in the prior art. However, none of these prior art systems are capable of accurately measuring the required loads i.e. weights. For example, we refer to WO 2010/136745 which although disclosing a load sensing system has been found to have a number of disadvantages. In particular, the sensors in WO 2010/136745 have been found to be inaccurate as it has been discovered that they allow a small amount of movement in the z-direction thereby allowing creep. This leads to inaccurate measurements. WO 2010/136745 is incorporated herein by reference.

The load sensing system described in the present invention may, for example, be used in measuring loads carried in vehicles. Although load measuring systems for vehicle trailers are known they have a number of disadvantages. For example, prior art systems tend to be located on the outside of the vehicle and need to be continually recalibrated as many prior art systems are dependent on spring systems. The springs are exposed to the weather and salt on the roads during winter and are therefore susceptible to corrosion which will alter the strength and hence the calibration of the springs. Even a coat of paint on the spring will require the system to be recalibrated.

Prior art methods for measuring the weight of trucks/trailers also rely on the load being transmitted through the trucks/trailers axles which again leads to inaccurate measurements.

It is an object of at least one aspect of the present invention to obviate or mitigate at least one or more of the aforementioned problems.

It is a further object of at least one aspect of the present invention to provide an improved apparatus for measuring and/or monitoring a load and/or distribution of a load.

It is a further object of at least one aspect of the present invention to provide an improved method for measuring and/or monitoring a load and/or distribution of a load.

### SUMMARY OF THE INVENTION

According to a first aspect of the present invention there is provided a load measuring sensor comprising:

a force sensing resistor securely located in a housing; and

a protruding member mounted on the force sensing resistor;

wherein on application of a load onto the protruding member this load is directly transferred to the force sensing resistor thereby allowing the applied load to be measured by the force sensing resistor.

The present invention therefore relates to using a load measuring sensor to measure and/or monitor an applied load.

The force sensing resistor may be securely fixed to the housing thereby preventing any movement in the x- and y-direction e.g. horizontally. The force sensing resistor may be securely fixed to the housing any suitable attachment means such as, for example, mechanical and/or adhesive means. For example, the force sensing resistor may be over-moulded or at least partially over-moulded with a plastics material (e.g. polyurethane).

In addition, the protruding member which may be seen as an actuating member acting against the force sensing resistor may also be fixed in position. The protruding member may therefore be centrally located and securely fixed in place on the force sensing resistor using mechanical and/or adhesive means.

By securely fixing the force sensing resistor to the housing and securely fixing the protruding member to the force sensing resistor has the function of preventing movement of the force sensing resistor in the x- and y-direction e.g. horizontally. Therefore, as the force sensing resistor and the protruding member which acts against it are fixed in place, the protruding member may only be allowed to move in the z-plane e.g. in the vertical direction. This allows accurate measurements to me made.

The force sensing resistor may measure loads of up to about 300 kg or even higher if necessary. The force sensing resistor may be amplified up to any required load.

The protruding member may be a solid device with a flat upper and lower surface to efficiently transmit the applied loads.

The housing may be a base casing made from any suitable plastics materials.

According to a second aspect of the present invention there is provided a method of measuring a load, said method comprising:

providing a force sensing resistor securely located in a housing; and providing a protruding member mounted on the force sensing resistor; wherein on application of a load onto the protruding member this load is directly transferred to the force sensing resistor thereby allowing the applied load to be measured by the force sensing resistor.

The method may use the load measuring sensor defined in the first aspect.

According to a third aspect of the present invention there is provided a panel capable of measuring and/or monitoring a load and/or distribution of a load, said panel comprising:

an upper member and a lower member wherein the upper and lower members are capable of being fitted together to form a sealed unit with an inner enclosure; and

locating at least one load measuring sensor in the inner enclosure formed by the upper and lower members;

wherein the at least one load measuring sensor is capable of measuring and/or monitoring an applied load and/or distribution of an applied load.

By fitting the upper and lower members together a continuous seal (e.g. a water-tight seal) may be formed. To form this seal at least one or both of the upper or lower members may comprise a depending structure (e.g. a rim) which extends fully around either of the upper or lower members. In particular embodiments, the lower member may be substantially flat and the upper member may comprise substantially orthogonal depending portions. To form a water-tight seal between the upper and lower members a foam sealing agent may be used.

The upper and lower members forming the panels which allow the load sensors to be enclosed within provide the further advantage in that the amount of space (i.e. the depth) taken up by the panels is relatively small and may, for example, be about 0.5-3 cm and particularly about 13 mm. The amount of load space that is lost by the use of the system according to the present invention is therefore relatively small.

The lower member may be substantially flat and is intended to be laid flat onto, for example, a load carrying area in a van or on a trailer for a lorry.

The upper and lower members may also comprise through holes through which attachment means such as bolts may be used to securely fix the panel in place.

Located between the upper and lower members there may be a plurality of load measuring sensors. The load measuring sensors may be as defined in the first aspect.

The load measuring sensors may be securely fixed in place onto the lower member of the panel. The load sensors may be securely attached to the lower member using any suitable attachment means such as, for example, mechanical and/or adhesive means. The fixing of the load sensors in place and only allowing the protruding member to move in the z-direction (i.e. vertically) prevents any slippage/creep/shear thereby allowing all of the load to be directing transferred to the load sensor thereby allowing accurate load measurements to be made. It has been found that if the load sensors are not secured in place then very small movements such as about 0.5 mm can have a significant impact on the measured load.

The upper member may be seen as forming a ‘floating layer’ onto which loads may be placed. The upper member may also be securely fixed in place thereby preventing any horizontal movement in the x- and y-plane. The upper member is however allowed to have vertical movement in the z-plane. This provides for accurate load measurements.

The panel may comprise any appropriate number of sections to make up the required size. The panel may be formed in a modular arrangement. By having a series of load sensors (e.g. any appropriate number such as eight) spread over each section and having a configuration of panels fully covering a load area allows not only accurate load measurements to be made but also allows the distribution of the load to be measured thereby allowing an assessment to be made if a load is insecure in, for example, a vehicle. Prior art systems such as measuring loads through vehicle axles have been found to have inaccuracies of around ±10% which can be significant if many tonnes are being measured. This can also lead to inefficiencies as the load being transported may be underweight or safety issues if the load is overweight. The present invention therefore prevents under- or over-loading and is therefore an intelligent based system. The present invention has been found to have increased accuracy, resolution and tolerance in measuring loads of about ±5% and preferably about ±3% of the measured load. The modularity of the system allows any size of panel to be quickly and cost-effectively built.

The modular arrangement, easy installation and low weight of the panels of the present invention allows a series of panels to be used in vehicle transportation systems that have a number of levels. For example, many supermarket chains now have trailers with 2 or 3 decks/levels to maximise the amount of load that can be carried. A panel according to the present invention can be used in each deck/level. This allows a measurement to be made on each deck/level. This is possible as the panels only take up a small amount of load space in comparison to prior art systems which are relatively thick and cumbersome and hence take up a large amount of load space.

Each of the sections in the panel may comprise a node which electronically connects up to, for example, a maximum of eight sensors. The load sensors may therefore provide a wide area spread of measurement which is therefore capable of providing accurate measurements.

The panel may also comprise cross-members to add strength to the sections. This also helps to distribute the load and hence further increasing the accuracy of the measurements.

The panels may be connected to a processor which may be used to process the necessary measurement and display the measurement on a display unit which may be located anywhere such as in the cab or driving area of a vehicle. The display unit may display the information in any suitable means such as in either a load indication form using a system of lights and/or is displayed in a format that enables a weight to be displayed in, for example, pounds and ounces or tones, kilograms and grams. In the event that the load measured exceeds a pre-set value for the maximum carrying load for the vehicle, then a warning signal may be sent to the driver. This warning signal may come in either the form of an audible warning or may be displayed on the display unit. The load sensors are also capable of measuring variations in the load during driving in the event that significant variations are detected. In the event that a shifting load is detected then a warning via an audible or visual signal may be sent to a driver by the display unit indicating that the load is in danger of unstabilising the vehicle. The information and measurements detected by the load sensors can be displayed inside a van or lorry. The information and measurements can also be transmitted wirelessly to a central control.

Due to the construction of the panels of the present invention, the panels can be used in any arrangement and not just horizontally but also vertically.

As the load sensors go to zero after each time they are used this allows for easy and accurate re-calibration. Prior art systems need to be regularly calibrated and are susceptible to temperature variations, fatigue and corrosion.

Although a specific use of the panels of the present invention is to measure a load and the distribution of a transported load in a vehicle other uses are also intended. For, example it is well known that at cross-border areas such as at the Channel Tunnel stowaways sometimes attempt to gain access to the UK by hiding themselves in transportation trailers. The system of the present invention could detect such a change in weight of the load and alert the driver or other relevant parties such as the immigration authorities. The panels of the present invention may also be used to monitor weekend use of a vehicle.

The panels of the present invention can also be used vertically. An example of such a use would be inside cargo containers where the panels may be used to monitor the outward pressure being exerted by container bags carrying, for example, fluid material. Container bags are secured for transit inside the cargo containers and in the event that the bags become loose then the panels of the present invention may also detect this situation.

In the transportation of prisoners the system can also be used as a backup system to alert the situation when prisoners have escaped from the back of a van. The panels of the present invention can therefore be used in security situations.

According to a fourth aspect of the present invention there is provided a method of using a panel to measure and/or monitor a load and/or distribution of a load, said method comprising:

providing an upper member and a lower member wherein the upper and lower member are capable of being fitted together to form a sealed unit with an inner enclosure; and

locating at least one load measuring sensor in the inner enclosure formed by the upper and lower members;

wherein the at least one load measuring sensor is capable of measuring and/or monitoring an applied load and/or distribution of an applied load.

The panel may be as defined in the third aspect.

### BRIEF DESCRIPTION OF THE DRAWINGS

Embodiments of the present invention will now be described, by way of example only, with reference to the accompanying drawings in which:

FIG. 1 is a cross-sectional side view of a panel comprising a load sensor according to an embodiment of the present invention;

FIG. 2 is a perspective view of a load sensor according to an embodiment of the present invention;

FIG. 3 is an exploded view of the load sensor shown in FIG. 2;

FIG. 4 is a sectional top view of a panel showing an array of load sensors according to an embodiment of the present invention; and

FIG. 5 is a sectional top view of a panel showing an array of load sensors according to a further embodiment of the present invention.

### BRIEF DESCRIPTION

Generally speaking, the present invention resides in the provision of a load sensor and a panels comprising said load sensors.

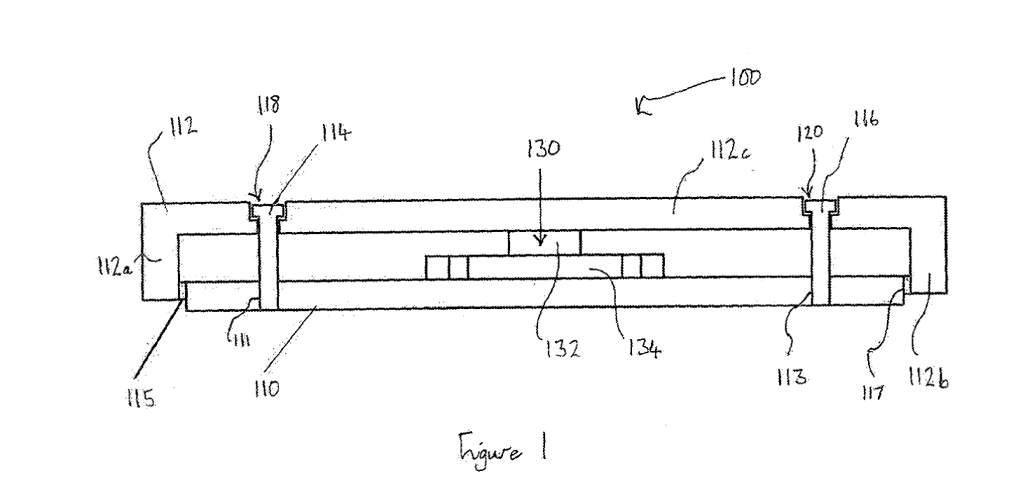

FIG. 1 is a sectional side view of a panel according to the present invention generally designated 100. The panel 100 comprises a lower member 110 and an upper member 112 which are, for example, made from metal plate. The lower member 110 is substantially flat and is intended to be laid flat onto, for example, a load carrying area in a van or on a trailer for a lorry. The lower member also comprises two through holes 111, 113. The upper member 112 extends over the lower member 110 and is substantially ‘U’-shaped with an extended substantially flat section 112c with two depending substantially orthogonal depending portions 112a, 112b. On the inner surface of the each of the depending portions 112a, 112b there is a seal 115, 117 (e.g. a foam seal) between the upper and lower members 112, 110. The foam seal forms a water-tight enclosure within which sensors may be located.

FIG. 1 also shows that the upper member 112 comprises two through holes 118, 120 which are located substantially above the through holes 111, 113 on the lower member 110. Inserted through the through holes 118, 120 and 111, 113 there are bolts 114, 116 (e.g. retaining shoulder bolts). The bolts 114, 116 secure the lower and upper members 110, 112 together. FIG. 1 also shows that the head of the bolts 114, 116 sit in recesses 118, 120 on the upper surface of the upper member 112 thereby providing a flat surface onto which loads may be placed.

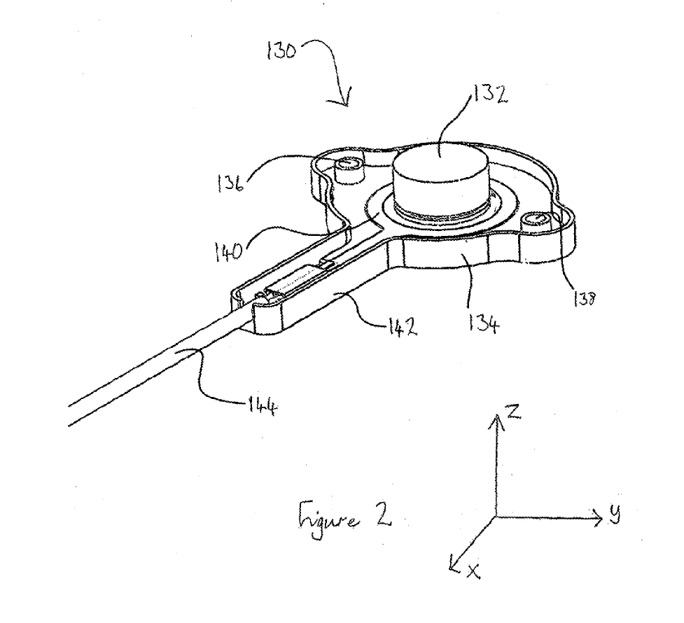

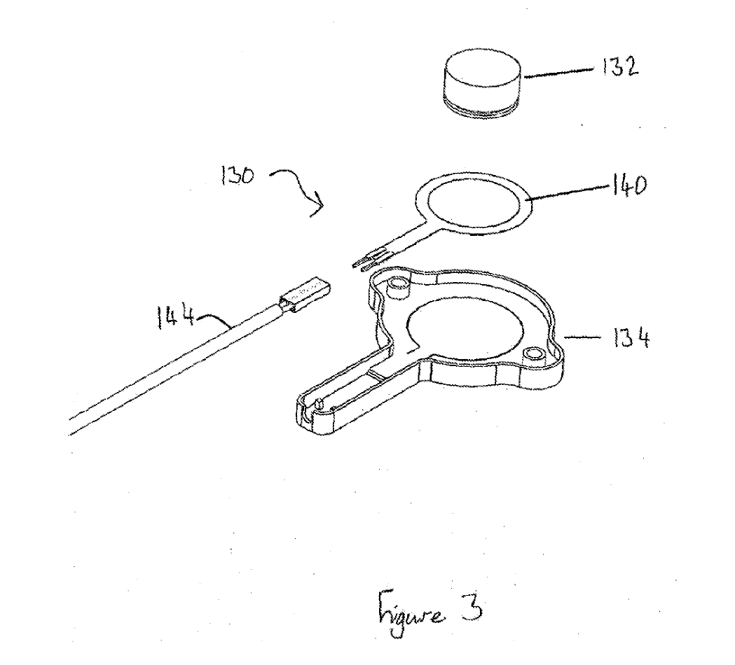

Located between the lower and upper members 110, 112 there is a load sensor 130. The load sensor 130 comprises a protruding member 132 (e.g. sometimes referred to as a ‘puck’) and a base casing 134. The load sensor 130 is securely attached to the lower member 1 10 using any suitable attachment means such as, for example, mechanical and/or adhesive means. In the embodiment shown in FIGS. 2 and 3 the base casing 134 is attached to the lower member 1 10 by inserting a screw or bolt through the holes 136, 138.

The upper member 1 12 may therefore be seen as forming a ‘floating layer’ onto which loads may be placed and transported. The upper member 1 12 by use of the bolts 1 14, 1 16 and the depending portions 1 12a, 1 12b also securely fixes the upper member 1 12 and prevents any horizontal movement in the x- and y-plane i.e. horizontal. The upper member 1 12 is however allowed to have horizontal movement in the z-plane. This provides for accurate load measurements.

FIGS. 2 and 3 are expanded views of the load sensor 130. The load sensor 130 comprises a protruding member 132 onto which loads are capable of being directed. As shown in FIGS. 2 and 3 there is a base casing 134 onto which the force sensing resistor 140 resides. A specific feature of the present invention is that the force sensing resistor 140 is securely attached within the confines of the outer casing 134 using any suitable attachment means such as, for example, mechanical and/or adhesive means. In the embodiment shown in FIGS. 2 and 3 the force sensing resistor 140 is over-moulded or at least partially over-moulded with a plastics material (e.g. polyurethane) This has the function of preventing any movement of the force sensing resistor 140 in the x- or y-direction i.e. horizontal movement. In the event that the force sensing resistor 140 is allowed to move in the x- or y-direction this has been found to lead to inaccuracies in the measurement of the load due to creep occurring. Therefore, as the force the force sensing resistor 140 is fixed in place the protruding member 132 is only allowed to move in the in the z-plane i.e. in the vertical direction.

FIGS. 2 and 3 also show that the load sensor 130 comprises an extended channel 142 through which an electrical lead 144 is fed.

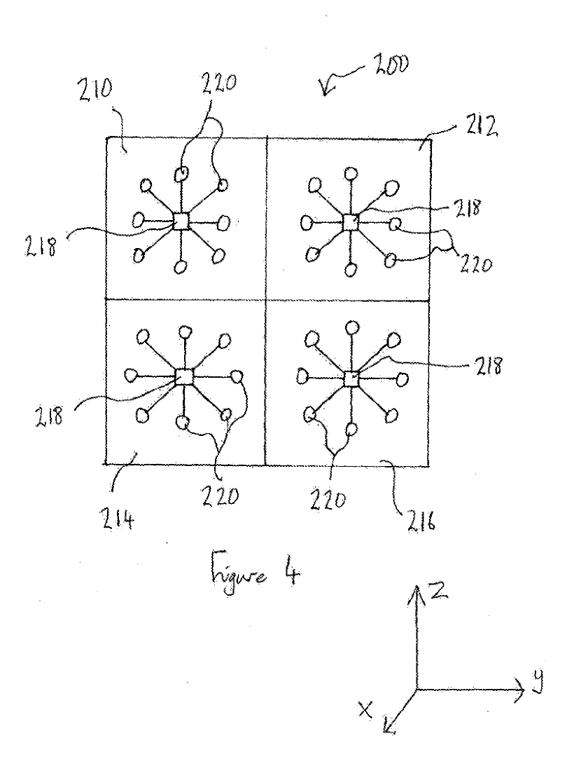

FIG. 4 is a panel 200 of the present invention comprising four sections 210, 212, 214, 216 in a 2×2 configuration. On each of the sections 210, 212, 214, 216 and as shown in the top sectional view there are four nodes 218. Connected to each of the nodes 218 there are eight load sensors 220. The load sensors 220 are as shown in FIGS. 2 and 3. As shown the load sensors 220 provide a wide spread area of measurement which is therefore capable of providing accurate measurements.

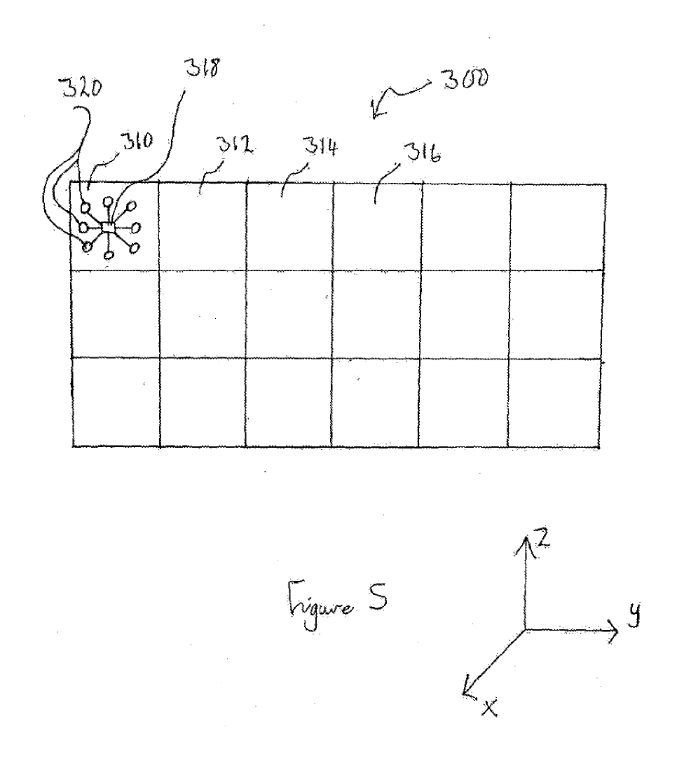

FIG. 5 is a view of a further panel 300 comprising eighteen sections 310, 312, 314, 316 etc. onto which a load is capable of being placed. Although only one of the nodes 318 is shown in section 310 a similar arrangement occurs in each of the other sections 312, 314, 316 etc. As shown the node 318 is connected to eight load sensors 320.

The load sensors of the present invention are capable of being amplified up to any required load. Each sensor is therefore capable of measuring up to about 300 kg or even higher if necessary.

Although not shown in FIGS. 4 and 5 a series of cross-members in optional embodiments may be used to add strength to the sections 210, 212, 214, 216, 310, 312, 314, 316 etc. containing the load sensors 220, 320. The cross-members add rigidity to the panels 200, 300 and help to distribute the load and hence further increasing the accuracy of the measurements.

In use, a panel 300, 400 such as shown in FIGS. 4 and 5 is capable of being constructed into any required size and then placed into the load area of, for example, a van or the trailer of a lorry. The panels 300, 400 are therefore capable of being pre-assembled in modular form and then fitted to measure and detect loads. The panels may be connected to a processor which may be used to process the necessary measurement and display the measurement on a display device which may be located anywhere such as in the cab or driving area of a vehicle. This is an advantage over prior art systems which are located on the outside of vehicles.

Continuous measurements may occur as a vehicle is being loaded so that the maximum weight of material may be transported by the vehicle but still at a safe level. The load sensors may also measure the distribution of the weight over the load carrying area of the vehicle thereby ensuring that the load is evenly distributed and ready for transport. This may help in the transport of heavy loads. The display unit can display the information in any suitable means such as in either a load indication form using a system of lights and/or is displayed in a format that enables a weight to be displayed in, for example, pounds and ounces or tones, kilograms and grams. In the event that the load measured exceeds a pre-set value for the maximum carrying load for the vehicle, then a warning signal may be sent to the driver. This warning signal may come in either the form of an audible warning or may be displayed on the display unit. The load sensors are also capable of measuring variations in the load during driving in the event that significant variations are detected. In the event that a shifting load is detected then a warning via an audible or visual signal may be sent to a driver by the display unit indicating that the load is in danger of de-stabilising the vehicle. The information and measurements detected by the load sensors can be displayed inside a van or lorry. The information and measurements can also be transmitted wirelessly to a central control.

The panels 200, 300 of the present invention have a number of technical advantages over prior art systems which are discussed below:

1. Due to the arrangement of the lower and upper members 110, 112 as shown in FIG. 1 and the seals 115, 117; the panels 100, 200, 300 of the present invention are capable of preventing any form of water ingress into the formed enclosure containing the load sensors. This not only provides a controlled environment to make the required measurements but will also increase the longevity of the panels 100, 200, 300.

2. The fixing of the load sensors 130 in place and only allowing the protruding member 132 to move on the z-direction (i.e. vertically) prevents any

slippage/creep/shear thereby allowing all of the load to be directly transferred to the load sensor 130 thereby allowing accurate load measurements to be made. It has been found that if the load sensors 130 are not secured in place then very small movements such as about 0.5 mm can have a significant impact on the measured load.

By having a series of load sensors (e.g. any appropriate number such as eight) spread over each section and having a configuration of panels fully covering a load area not only allows accurate load measurements to be made but also allows the distribution of the load to be measured thereby allowing an assessment to be made if a load is insecure in, for example, a vehicle. Prior art systems such as measuring loads through vehicle axles have been found to have inaccuracies of around ±10% which can be significant if many tonnes are being measured and transported. This can also lead to inefficiencies as the load being transported may be underweight or safety issues if the load is overweight. The present invention therefore prevents under- or over-loading and is therefore an intelligent based system. The present invention has been found to have increased accuracy, resolution and tolerance in measuring loads of about ±5% and preferably about ±3% of the measured load.

The upper and lower members forming the panels which allow the load sensors to be enclosed within provide the further advantage in that the amount of space (i.e. the depth) taken up by the panels is relatively small and may, for example, be about 1-3 cm and particularly about 13 mm.

The amount of load space that is lost by the use of the system according to the present invention is therefore relatively small.

By use of the panels and the load sensors located below the upper member forming the panels allows a reduced number of load sensors to be used thereby minimizing costs.

The modular arrangement, easy installation and low weight of the panels of the present invention allows a series of panels to be used in vehicle transportation systems that have a number of levels. For example, many supermarket chains now have trailers with 2 or 3 decks/levels to maximise the amount of load that can be carried. A panel according to the present invention can be used in each deck/level. This allows a measurement to be made on each deck/level. This is possible as the panels only take up a small amount of load space in comparison to prior art systems which are relatively thick and cumbersome and hence take up a large amount of load space.

The panels of the present invention provide instantaneous feedback regarding the load and the distribution of the load which provides both safety and security advantages.

Due to the construction of the panels of the present invention, the panels can be used in any arrangement and not just horizontally but also vertically.

As the load sensors go to zero after each time they are used this allows for easy and accurate re-calibration. Prior art systems need to be regularly re-calibrated and are susceptible to temperature variations, fatigue and corrosion.

10. The modularity of the system allows any size of panel to be quickly and cost-effectively built.

Although a specific use of the panels of the present invention is to measure a load and the distribution of a transported load in a vehicle other uses are also intended. For, example it is well known that at cross-border areas such as at the Channel Tunnel stowaways sometimes attempt to gain access to the UK by hiding themselves in transportation trailers. The system of the present invention could detect such a change in weight of the load and alert the driver or other relevant parties such as the immigration authorities. The panels of the present invention may also be used to monitor weekend use of a vehicle.

The panels of the present invention can also be used vertically. An example of such a use would be inside cargo containers where the panels may be used to monitor the outward pressure being exerted by container bags carrying, for example, fluid material. Container bags are secured for transit inside the cargo containers and in the event that the bags become loose then the panels of the present invention may also detect this situation.

In the transportation of prisoners the system can also be used as a back-up system to alert the situation when prisoners have escaped from the back of a van. The panels of the present invention can therefore be used in security situations.

Whilst specific embodiments of the present invention have been described above, it will be appreciated that departures from the described embodiments may still fall within the scope of the present invention. For example, any suitable type of panel construction may be used. Moreover, any type of force sensing resistor may be used.

1-37. (canceled)

38. A panel capable of measuring and/or monitoring a load and/or distribution of a load, said panel comprising:
an upper member and a lower member wherein the upper and lower member are capable of being fitted together to form a continuous water-tight sealed unit with an inner enclosure wherein to form this seal at least one or both of the upper or lower members comprises a depending structure in the form of a rim which extends fully around either of the upper or lower members;
locating a plurality of load measuring sensors in the inner enclosure formed by the upper and lower members;
wherein the at least one load measuring sensor is capable of measuring and/or monitoring an applied load and/or distribution of an applied load;
wherein by having a series of load sensors spread over the panel and having a configuration of panels fully covering a load area allows not only accurate load measurements to be made but also allows the distribution of the load to be measured thereby allowing an assessment to be made if a load is insecure in a vehicle; and
wherein the upper member is securely fixed in place thereby preventing any horizontal movement in the x- and y-plane but is allowed to have vertical movement in the z-plane which provides for accurate load measurements.

39. A panel capable of measuring and/or monitoring a load and/or distribution of a load according to claim 38, wherein the lower member is substantially flat and the upper member comprises substantially orthogonal depending portions and therefore forms a substantially ‘U’-shaped structure; and wherein to form a water-tight seal between the upper and lower members a foam sealing agent is used.

40. A panel capable of measuring and/or monitoring a load and/or distribution of a load according to claim 38, wherein the upper and lower members forming the panels allow the load sensors to be enclosed within a small amount of space (i.e. the depth) taken up by the panels such as about 1-3 cm and particularly about 13 mm; and
wherein the lower member is substantially flat and is intended to be laid flat onto, for example, a load carrying area in a van or on a trailer for a lorry.

41. A panel capable of measuring and/or monitoring a load and/or distribution of a load according to claim 38, wherein the upper and lower members also comprise through holes through which attachment means such as bolts are used to securely fix the panel in place; and
wherein the load measuring sensors are securely fixed in place onto the lower member of the panel.

42. A panel capable of measuring and/or monitoring a load and/or distribution of a load according to claim 41, wherein the load sensors are securely attached to the lower member using any suitable attachment means such as, for example, mechanical and/or adhesive means; and wherein the fixing of the load sensors in place and only allowing the protruding member to move in the z-direction (i.e. vertically) prevents any slippage/creep/shear thereby allowing all of the load to be directing transferred to the load sensor thereby allowing accurate load measurements to be made.

43. A panel capable of measuring and/or monitoring a load and/or distribution of a load according to claim 38, wherein the panel comprises any appropriate number of sections to make up the required size such as in a modular arrangement;
wherein a modular arrangement, easy installation and low weight of the panels allows a series of panels to be used in vehicle transportation systems that have a number of levels to maximize the amount so load that can be carried.

44. A panel capable of measuring and/or monitoring a load and/or distribution of a load according to claim 38, wherein each of the sections in the panel comprises a node which electronically connects up to, for example, a maximum of eight sensors i.e. the load sensors provide a wide area of measurement which is therefore capable of providing accurate measurements; wherein the panel comprises cross-members to add strength to the sections which helps to distribute the load and hence further increasing the accuracy of the measurements; and wherein the panels are connected to a processor which is used to process the necessary measurements and display the measurements on a display unit which can be located anywhere such as in the cab or driving area of a vehicle.

45. A panel capable of measuring and/or monitoring a load and/or distribution of a load according to claim 44, wherein the display unit displays the information in any suitable means such as in either a load indication form using a system of lights and/or is displayed in a format that enables a weight to be displayed in, for example, pounds and ounces or tones, kilograms and grams whereby in the event that the load measured exceeds a pre-set value for the maximum carrying load for the vehicle, then a warning signal may be sent to the driver or is displayed on the display unit;
wherein the panels are capable of being used horizontally or vertically; and wherein as the load sensors go to zero after each time they are used which allows for easy and accurate re-calibration.

46. A load measuring sensor comprising:
a force sensing resistor securely located in a housing; and
a protruding member mounted on the force sensing resistor;
wherein on application of a load onto the protruding member this load is directly transferred to the force sensing resistor thereby allowing the applied load to be measured by the force sensing resistor;
wherein the force sensing resistor is securely fixed to the housing thereby preventing any movement in the x- and y-direction e.g. horizontally; and wherein the protruding member is centrally located and securely fixed in place on the force sensing resistor using mechanical and/or adhesive means; a load measuring sensor according to any claims and wherein by securely fixing the force sensing resistor to the housing and securely fixing the protruding member to the force sensing resistor has the function of preventing movement of the force sensing resistor in the x- and y-direction (e.g. horizontally) and the protruding member is only allowed to move in the z-plane e.g. in the vertical direction.

47. A load measuring sensor according to claim 46, wherein the force sensing resistor is securely fixed to the housing any suitable attachment means such as, for example, mechanical and/or adhesive means; and wherein the force sensing resistor may is over-molded or at least partially over-molded with a plastics material.

48. A load measuring sensor according to claim 46, wherein the force sensing resistor is capable of measuring loads of up to about 300 kg or even higher if necessary.

49. A load measuring sensor according to claim 46, wherein the protruding member is a solid device with a flat upper and lower surface to efficiently transmit the applied loads.

50. A load measuring sensor according to claim 46, wherein the housing is a base casing made from any suitable plastics materials.

51. The load measuring sensor of claim 47, wherein the plastics material is polyurethane.

52. The panel of claim 43, wherein the transportation that has a number of levels is a trailer with 2 or 3 decks/levels.

53. The panel of claim 45, wherein the warning signal is sent to the driver in the form of an audible warning.

54. The panel of claim 45, wherein the panel is capable of being used inside cargo containers.
